(19) United States
(12) Patent Application Publication
(10) Pub. No.: US 2011/0219685 A1
(43) Pub. Date: Sep. 15, 2011

(54) Vacuum Regulated Dual Tube Fluid Delivery System

(76) Inventor: John Thomas Goldman, New York, NY (US)

(21) Appl. No.: 12/723,314

(22) Filed: Mar. 12, 2010

(51) Int. Cl. A01G 1/00; F16L 35/00

(52) U.S. Cl. 47/58.1 R; 47/1.1 R; 137/800

(57) ABSTRACT

A vacuum regulated fluid delivery system is disclosed. The fluid delivery system may have a cap configured to receive a closed reservoir of fluid. The cap may have first and second openings extending from the cap. The first opening may have a first external nozzle for carrying water or other fluid from the closed reservoir to an open reservoir. The second opening may have a second external nozzle for allowing air to flow into and out of the first reservoir. The fluid delivery system may also have a tube terminal unit having first and second openings. The first tube terminal opening may have a first nozzle connected to the first external nozzle of the cap by a flexible tube for receiving water or other fluid from the closed reservoir and delivering it to an open reservoir out a fluid delivery outlet. The second tube terminal opening may have a second nozzle connected to the second external nozzle of the cap by a flexible tube for allowing air to flow into an air intake valve on the tube terminal unit to the closed reservoir.

### TECHNICAL FIELD

The present disclosure relates generally to a fluid delivery system and, more particularly, a water delivery system for maintaining a constant fluid level in an open fluid reservoir.

### BACKGROUND

A cut Christmas tree is customarily placed in a tree stand. The conventional tree stand has a cup or cavity located near the cut portion of the tree that is filled with water. The water helps the tree maintain internal hydration and retain its needles. A cut tree can absorb a couple of quarts a day. The water level within a tree stand requires continual attention as consumption by the tree and evaporation continuously depletes the water. Maintenance of the water level within the tree stand is a critical factor in the longevity and vitality of the tree.

An exemplary Christmas tree irrigation device is disclosed in U.S. Pat. No. 4,653,224 (the '224 patent) issued to Weckesser on Mar. 31, 1987. The '224 patent describes a single tube continuous flow system that has two reservoirs open to the atmosphere. This system increases the flow of water from an open container, located near the tree stand, to a cavity in the tree stand. The water level in the reservoir and the water level in the tree stand pan will always be equal.

Although the fluid delivery system of the '224 patent may improve a continuous flow of water to a reservoir for cut trees, its application and benefit to fluid delivery systems may be limited. That is, the '224 patent describes an open system that utilizes an open reservoir placed on the floor near the tree. Conventional irrigation systems of this type do not keep the water in the tree stand cavity at a constant level. The result is that not all of the water in the separate open reservoir is used for irrigation, and the system requires the user to more frequently monitor and refill the open reservoir. In addition, this conventional irrigation system takes up unnecessary floor space and poses the risk of tipping over and spilling. Lastly, the open top system is also subject to evaporative loss of water, resulting in an inefficient system. As water from the tree stand pan and reservoir is consumed or evaporates, the water level in the tree stand lowers, possibly exposing the cut portion of the tree which would result in accelerated dying of the tree, even though there still may be considerable fluid in the reservoir.

The disclosed fluid deliver system is directed to overcoming one or more of the problems set forth above.

### SUMMARY

In one aspect, the present disclosure is directed to a fluid deliver system. The fluid delivery system may include a cap configured to threadably engage the first reservoir of fluid creating an air tight seal and a tube terminal unit. The cap comprises means for securing the cap to a fixed structure or a portion of a plant and has first and second cap openings extending from the cap. The first cap opening carries fluid from the reservoir and the second cap opening carries air into the reservoir. The first cap opening having a first external nozzle and a first internal nozzle and the second cap opening having a second external nozzle and a second internal nozzle. The first and second external nozzles and the first internal nozzle have a cylindrical shape and a ribbed distal end.

The tube terminal unit comprising a first tube terminal opening and a second tube terminal opening. The first tube terminal opening having a first tube terminal nozzle and a fluid delivery outlet and the second tube terminal opening having a second tube terminal nozzle and an air intake opening. The first cap opening and the first tube terminal opening are connected by a first flexible tube and the second cap opening and the second terminal opening are connected by a second flexible tube. The second tube terminal opening has a priming bulb. The tube terminal unit comprises means for securing the tube terminal unit to a second reservoir of fluid or a lower portion of a plant.

In another aspect, the present disclosure is directed to a method of using a fluid delivery system comprising securing a cap, having a first and second cap opening and configured to receive a first reservoir of fluid, to a fixed structure or a portion of a plant. Securing a tube terminal unit, having a first and second tube terminal opening, to a second reservoir of fluid or a lower portion of a plant. Connecting a first flexible tube to the first cap opening and the first tube terminal opening, and connecting a second flexible tube to the second cap opening and the second tube terminal opening. The first flexible tube carries fluid from the first reservoir to the second reservoir and the second flexible tube carries air to the first reservoir. The first flexible tube delivers fluid to the second reservoir through the first tube terminal opening and a fluid delivery outlet. The second flexible tube delivers air to the first reservoir through an air intake opening and the second tube terminal opening. The method includes pressing a priming bulb to initiate air to travel up the second flexible tube to the first reservoir.

### BRIEF DESCRIPTION OF THE DRAWINGS

FIG. 1 is a schematic illustration of an exemplary disclosed fluid delivery system;

FIG. 2 is an enlarged diagrammatic illustration of the nozzle apparatus in the fluid delivery system of FIG. 1;

FIG. 3 is an enlarged diagrammatic illustration of the bottom surface of the nozzle apparatus in the fluid delivery system of FIG. 1;

FIG. 4A is an enlarged diagrammatic illustration of the tube terminal apparatus of the fluid delivery system of FIG. 1;

FIG. 4B is an enlarged diagrammatic illustration of the tube terminal apparatus of the fluid delivery system of FIG. 1;

FIG. 5A-FIG. 5C are diagrammatic illustrations of the securing means of the tube terminal apparatus of the fluid delivery system of FIG. 1; and

FIG. 5D is an diagrammatic illustration of an alternative embodiment of the tube terminal apparatus of the fluid delivery system of FIG. 1.

### DETAILED DESCRIPTION

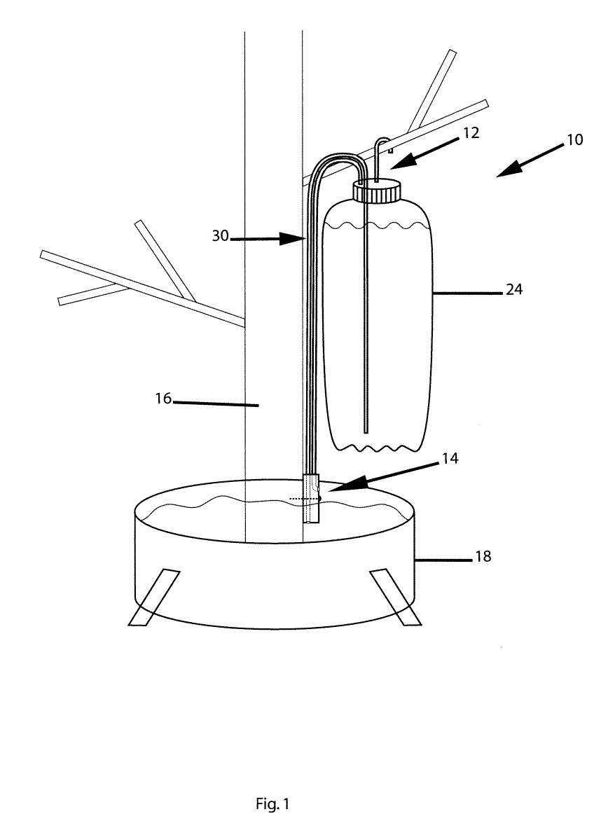

FIG. 1 illustrates an exemplary fluid delivery system 10. The fluid delivery system 10 may be configured to provide water or any other nutrient, preservative and fire-retardant solutions to open reservoir 18 in order to maintain a constant fluid level in reservoir 18. In one exemplary embodiment, the fluid deliver system 10 may be attached to a lower branch of a tree or other plant to provide water to an open reservoir where a cut end of the tree or plant is located. As shown in FIG. 1, fluid deliver system 10 may comprise nozzle apparatus 12 and tube terminal apparatus 14. Although nozzle apparatus 12 is shown attached to the lower branch of tree 16, it is contemplated that nozzle apparatus 12 may be attached to any portion of the tree or plant, or any free standing support structure. Tube terminal apparatus 14 may be attached to open reservoir 18, the trunk of the tree or plant. Although open reservoir 18 is shown as a tree stand, it is contemplated that any tree stand or Christmas tree with an open reservoir to hydrate a tree may be used with fluid delivery system 10. Alternatively, fluid delivery system 10 may also be used with a tree stand having a reservoir separate or removable from the stand.

Nozzle apparatus 12 may include components to secure the nozzle apparatus to tree 16 and to deliver water to open reservoir 18. In one embodiment, nozzle apparatus 12 may comprise cap 20, hook 22, and closed reservoir 24. Closed reservoir 24 is shown as a common plastic soda bottle; however, for the purposes of this disclosure, closed reservoir 24 may embody any type of container for holding fluid. One skilled in the art will recognize that closed reservoir 24 may be any type of sized bottle, for example but not limited to, a soda bottle, a water bottle, a larger gallon sized beverage bottle, a bottle made from plastic, glass, synthetic resin or other desired material based on the fluid used, or any specially manufactured decorative reservoir.

Nozzle apparatus 12 creates an airtight seal with the water closed reservoir 24 and allows the closed reservoir 24 bottle to be suspended from a tree branch, above the tree stand's open reservoir 18. Nozzle apparatus 12 has first 26 and second 28 openings. First opening 26 and second opening 28 each has an internal nozzle extending in to the closed reservoir 24 and an external nozzle extending away extending away from a top portion nozzle apparatus 12. Attached to the external nozzles are first end of flexible tubes 30. Flexible tubes 30 may comprise fluid conduit 32 for the delivery of water from the closed reservoir 24 to the open reservoir 18, and air conduit 34 for the return of air (or any other fluid or gas as another application may require) to closed reservoir 24.

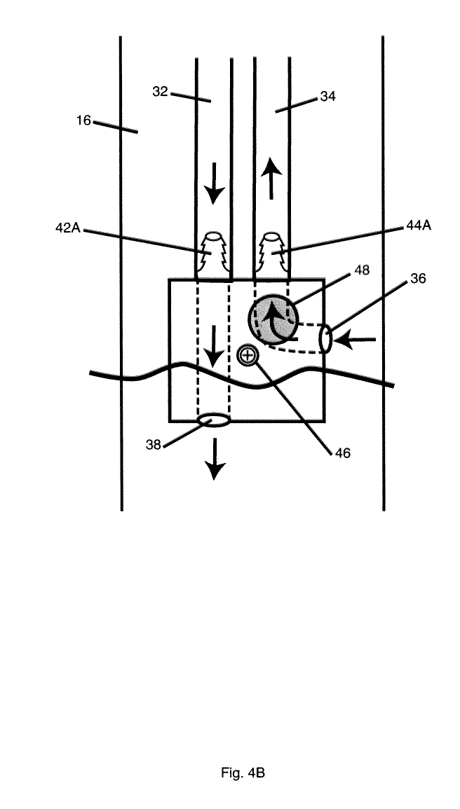

Tube terminal unit 14 allows for the fixed attachment of second end of flexible tubes 30. When the water level within the tree open reservoir drops below the level of air intake valve 36 (shown in detail in FIGS. 4A and 4B) of tube terminal unit 14, air enters air conduit 34 and into closed reservoir 24 releasing the vacuum and allowing gravity to cause the water to flow from the closed reservoir 24, through fluid conduit 32, out fluid delivery outlet 38 (shown in detail in FIGS. 4A and 4B), and into the open reservoir 18 until the water level rises up to air intake valve 36. Once the water level covers air intake valve 36, air can no longer enter the closed reservoir 24 via air conduit 34, vacuum pressure builds and—prevents the flow of the water from closed reservoir 24 into the open reservoir 18. The system will continue to flow and stop as described until closed reservoir 24 is emptied. This allows the tree to remain hydrated for a much longer period of time than would be possible with only the water in the open reservoir without any effort on the part of the user.

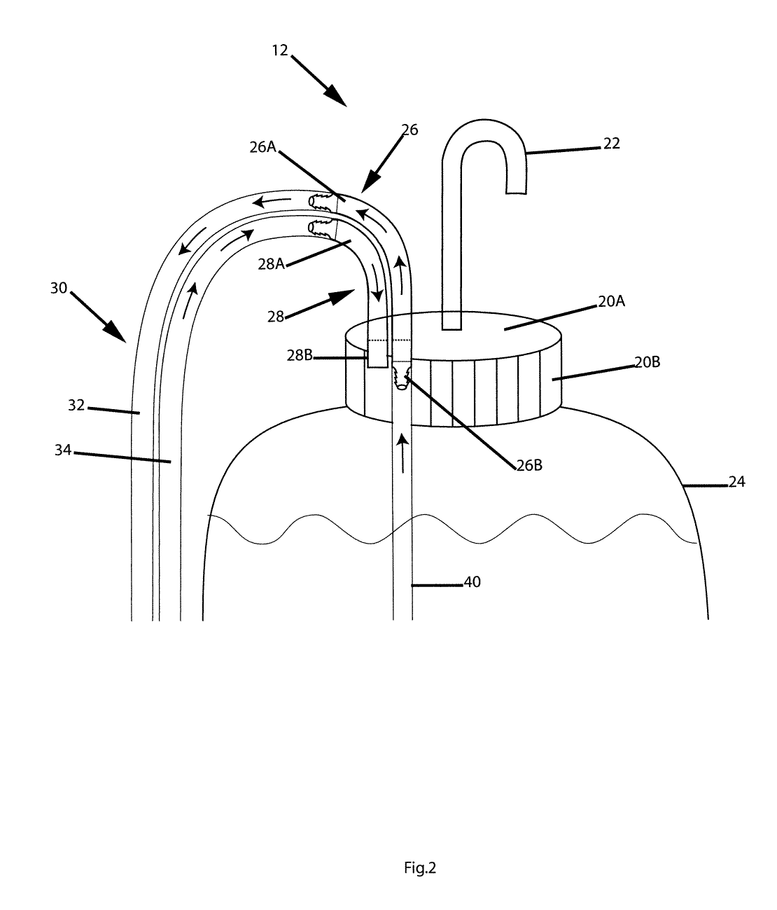

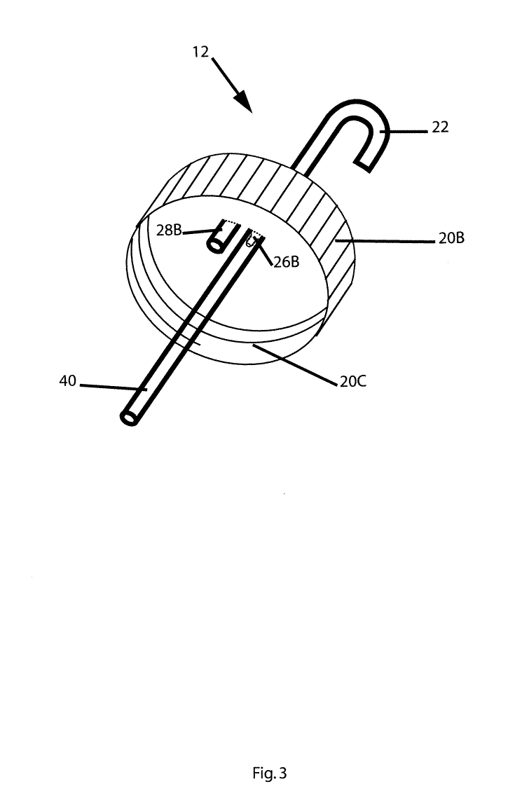

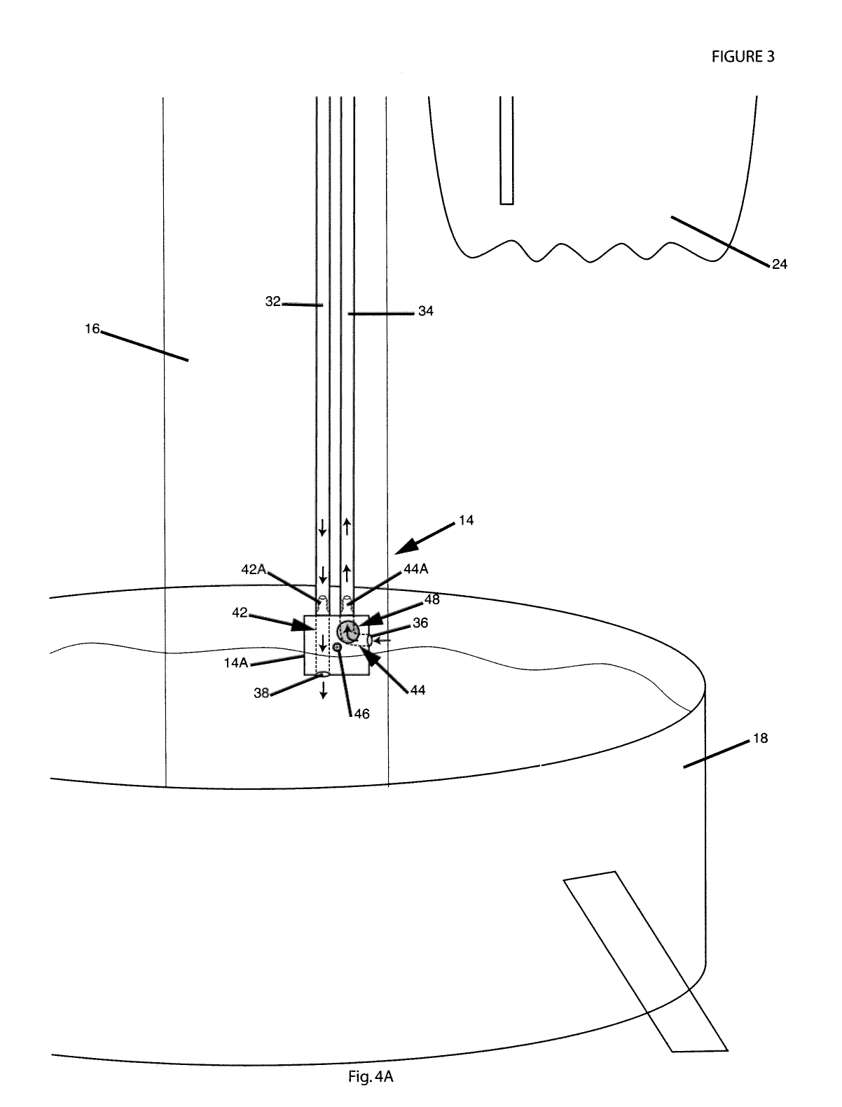

FIG. 2 illustrates an exemplary embodiment of nozzle apparatus 12. Nozzle apparatus 12 may include cap 20. Cap 20 has top portion 20A and cylindrical sidewall portion 20B. Cap 20 may include a hook 22 or other fastening means secured to top portion 20A. Cap 20 and hook 22 may be made by plastic injection molding or a synthetic resin. In one embodiment, cap 20 and hook 22 are made from one integral piece. In another embodiment, hook 20 or other fastening means may be separate from cap 20. Hook 20 allows the nozzle apparatus 12 to be suspended above the open reservoir 18 so that gravity can push water or fluid out of the closed reservoir 24 and into the open reservoir 18. As seen in FIG. 3, cylindrical sidewall portion 20B has internal threads 20C threadably engaged with a threaded portion of closed reservoir 24, creating a seamless and airtight connection.

Cap 20 may include first opening 26 and second opening 28 integrally formed herewith. First opening 26 comprises external nozzle 26A and internal nozzle 26B. External nozzle 26A has a cylindrical shape and a ribbed distal end. First end of fluid conduit 32 is securely fastened by a frictional engagement to the ribbed distal end of external nozzle 26A. Internal nozzle 26B has a cylindrical shape and a ribbed distal end. First end of internal fluid conduit 40 is securely fastened by a frictional engagement to the ribbed distal end of internal nozzle 26B. Second end of internal fluid conduit 40 extends the axial length of the closed reservoir 24. Second opening 28 comprises external nozzle 28A and internal nozzle 28B. External nozzle 28A has a cylindrical shape and a ribbed distal end. First end of air conduit 34 is securely fastened by a frictional engagement to the ribbed distal end of external nozzle 28A. Internal nozzle 28B has a cylindrical shape and is open to the atmosphere of the closed reservoir 24.

FIGS. 4A and 4B illustrate an exemplary embodiment of tube terminal apparatus 14. Tube terminal apparatus 14 is a one-piece apparatus and may be made by plastic injection molding or a synthetic resin. Tube terminal apparatus 14 has a generally rectangular shape having an upper surface, a bottom surface, and two oppositely facing side walls 14A connecting the upper and bottom surfaces. Tube terminal apparatus my be square, round, or may be made into any decorative or useful shape. Tube terminal apparatus 14 may include first opening 42 and second opening 44 integrally formed herewith. First opening 42 comprises external nozzle 42A on the upper surface of tube terminal apparatus 14 and fluid delivery outlet 38 on the bottom surface of tube terminal apparatus 14. External nozzle 42A has a cylindrical shape and a ribbed distal end. Second end of fluid conduit 32 is securely fastened by a frictional engagement to the ribbed distal end of external nozzle 42A. Fluid delivery outlet 38 has a cylindrical shape and is open to the water or fluid in the open reservoir 18. Second opening 44 comprises external nozzle 44A and air intake valve 36. External nozzle 44A has a cylindrical shape and a ribbed distal end. Second end of air conduit 34 is securely fastened by a frictional engagement to the ribbed distal end of external nozzle 44A. Air intake valve 36 has a cylindrical shape and is located substantially in the middle of one of first or second side walls 14A. Air intake valve 36 is open to the atmosphere and is placed at the desired fluid level.

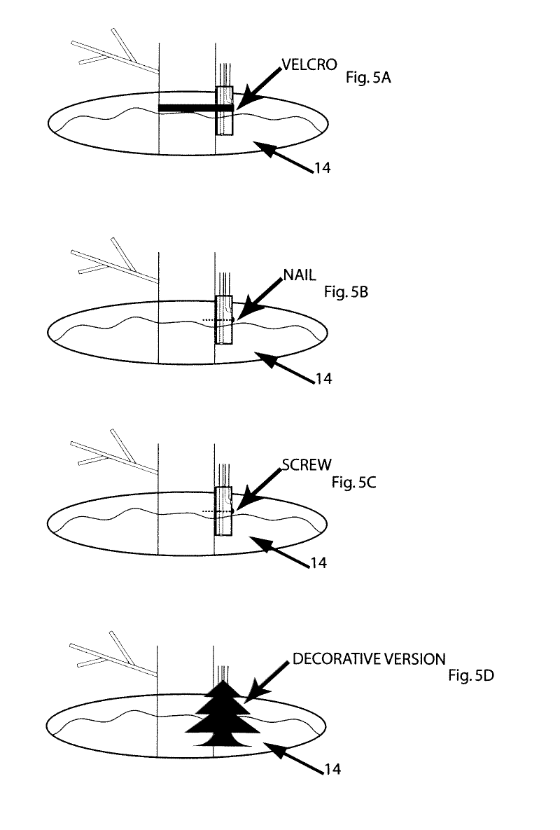

Tube terminal apparatus 14 may include fixing means 46 attached to first or second side wall 14A. In one embodiment, first or second side wall 14A and hook fixing means 46 are made from one integral piece. It is contemplated that fixing means 46 may comprise spikes or other sharp protrusions for securing tube terminal 14 to the trunk of the tree or other plant. In another embodiment, fastening means 46 may be separate from tube terminal apparatus 14. As shown in FIGS. 5A through 5C, it is contemplated that fixing means 46 may comprise nails, screws, hook and loop and fastening strap, or a plastic zip fastener. In this embodiment, tube terminal apparatus may include means attached to the first or second sidewalls 14A for the nails, screws, hook and loop fastening strap, or plastic zip fastener to pass through, securing the tube terminal apparatus to the trunk of the tree or other plant. Fixing means 46 allows tube terminal apparatus 14 to be fixed at a desired location relative to open reservoir 18. Fixing the location of tube terminal apparatus 14 fixes the location of the air intake valve 36 and fixes the desired water level in open reservoir 18.

In one embodiment, second opening 44 may include rubber bulb 48 between external nozzle 44A and air intake valve 36. Rubber bulb 48 may be used to prime the fluid delivery system. Pressing the rubber bulb 48 will cause air to travel up air conduit 34 and into closed reservoir 24, creating a small amount of initial pressure required to prime the system and allow water to begin to flow by gravity from the closed reservoir 24, through fluid conduit 32, out fluid delivery outlet 38, and into the open reservoir 18 until the water level rises up to air intake valve 36. Once the water lever covers air intake valve 36, air can no longer enter the closed reservoir 24 via air conduit 34, vacuum pressure builds and—prevents the flow of the water from closed reservoir 24 into the open reservoir 18. The system will continue to flow and stop as described, without need for additional priming, until closed reservoir 24 is emptied. Once closed reservoir 24 is emptied, it may then be unscrewed from cap 20, refilled with water or other fluid, and reattached to cap 20.

The disclosed fluid deliver system may be used in any application where fluid is to be transported from a closed reservoir of fluid to an open reservoir of fluid. In particular, the fluid deliver system may provide optimal fluid flow when the nozzle apparatus is installed at any distance from the tube terminal apparatus such that optimal fluid level is maintained in the open reservoir. The operation of fluid delivery system 10 will now be described.

During operation of fluid delivery system 10, closed reservoir 24 is filled with the desired fluid and then threadably attached to cap 20. Hook 22 of cap 20 is then attached to the lower branch of tree 16, or to any portion of the tree or of a free standing support structure. Tube terminal apparatus 14 is then fixed, via fixing means 46, to the tree or to the open reservoir 18. Air intake valve 36 of tube terminal apparatus 14 is place at the desired water level in open reservoir 18 and then tube terminal apparatus 14 is fixed.

After the tube terminal apparatus 14 is fixed, an initial amount if fluid is poured into open reservoir 18 just below air intake valve 36. To initiate the flow of fluid, rubber bulb 48 is primed, or pressed repeatedly. This causes air to travel up air conduit 34 and into closed reservoir 24, creating a small amount of initial pressure and allows water to begin to flow by gravity from the closed reservoir 24, through fluid conduit 32, out fluid delivery outlet 38, and into the open reservoir 18. The water level will rise up until the level fixed by air intake valve 36. Once the water lever covers air intake valve 36, air can no longer enter the closed reservoir 24 via air conduit 34, vacuum pressure builds and prevents the flow of fluid from closed reservoir 24 into the open reservoir 18. As the fluid is soaked up the tree or plant, or is evaporated, the water level will drop below air intake valve 36, air will again travel up air conduit 34 and into closed reservoir 24. The operation will repeat, without need for additional priming, until closed reservoir 24 is emptied. Once closed reservoir 24 is emptied, it may then be unscrewed from cap 20, refilled with water or other fluid, and reattached to cap 20.

What is claimed is:

1. A fluid delivery system comprising:
a cap;
the cap configured to receive a first reservoir of fluid;
a first cap opening and a second cap opening extending from the cap, wherein the first cap opening carries fluid from the reservoir.

2. The fluid delivery system of claim 1, wherein the second cap opening carries air into the first reservoir.

3. The fluid delivery system of claim 2, wherein
the first cap opening has a first external nozzle and a first internal nozzle; and
the second cap opening has a second external nozzle and a second internal nozzle.

4. The fluid delivery system of claim 3, wherein the first and second external nozzles and the first internal nozzle have a cylindrical shape and a ribbed distal end.

5. The fluid delivery system of claim 1, wherein the cap is configured to threadably engage the first reservoir creating an air tight seal, and the cap comprises means for securing the cap to a fixed structure or a portion of a plant.

6. The fluid delivery system of claim 2, further comprising a tube terminal unit, the tube terminal unit comprising:
a first tube terminal opening; and
a second tube terminal opening.

7. The fluid deliver system of claim 6, wherein
the first tube terminal opening has a first tube terminal nozzle and a fluid delivery outlet; and
the second tube terminal opening has a second tube terminal nozzle and an air intake opening.

8. The fluid deliver system of claim 6, wherein the first cap opening and the first tube terminal opening are connected by a first flexible tube; and
the second cap opening and the second terminal opening are connected by a second flexible tube.

9. The fluid deliver system of claim 8, wherein the second tube terminal opening has a priming bulb.

10. The fluid deliver system of claim 8, wherein a third flexible tube is connected to a first internal nozzle of the first cap opening and extends the length of the first reservoir.

11. The fluid delivery system of claim 3, further comprising a tube terminal unit, the tube terminal unit comprising:
a first tube terminal opening having a first tube terminal nozzle and a fluid delivery outlet; a second tube terminal opening having a second tube terminal nozzle and an air intake opening;
wherein a first flexible tube connects the first external nozzle and the first tube terminal nozzle, and a second flexible tube connects the second external nozzle and the second tube terminal nozzle.

12. The fluid deliver system of claim 11, wherein the second tube terminal opening has a priming bulb.

13. The fluid deliver system of claim 6, wherein the tube terminal unit comprises means for securing the tube terminal unit to a second reservoir of fluid or a lower portion of a plant.

14. A method of using a fluid delivery system comprising:
securing a cap, having a first and second cap opening and configured to receive a first reservoir of fluid, to a fixed structure or a portion of a plant;
securing a tube terminal unit, having a first and second tube terminal opening, to a second reservoir of fluid or a lower portion of a plant;
connecting a first flexible tube to the first cap opening and the first tube terminal opening; and
connecting a second flexible tube to the second cap opening and the second tube terminal opening.

15. The method of using the fluid delivery system of claim 14, wherein the first flexible tube carries fluid from the first reservoir to the second reservoir; and
wherein the second flexible tube carries air to the first reservoir.

16. The method of using the fluid delivery system of claim 15, wherein the first flexible tube delivers fluid to the second reservoir through the first tube terminal opening and a fluid delivery outlet; and
wherein the second flexible tube delivers air to the first reservoir through an air intake opening and the second tube terminal opening.

17. The method of using the fluid delivery system of claim 16, including pressing a priming bulb to initiate air to travel up the second flexible tube to the first reservoir.

18. The method of using the fluid delivery system of claim 14, wherein securing the tube terminal unit includes means for securing the tube terminal unit.

19. The method of using the fluid delivery system of claim 14, wherein securing the tube terminal unit includes placing an air intake valve at a desired water level of the second reservoir.

20. A fluid delivery system comprising:
a cap;
the cap configured to receive a first reservoir of fluid;
a first cap opening and a second cap opening extending from the cap, wherein the first cap opening carries fluid from the reservoir and the second cap opening carries air into the first reservoir;
a tube terminal unit comprising a first tube terminal opening and a second tube terminal opening;
wherein the first cap opening and the first tube terminal opening are connected by a first flexible tube and the second cap opening and the second terminal opening are connected by a second flexible tube; and
wherein a third flexible tube is connected to a first internal nozzle of the first cap opening and extends the length of the first reservoir.
